(19) United States
(12) Patent Application Publication
(10) Pub. No.: US 2021/0177066 A1
(43) Pub. Date: Jun. 17, 2021

(54) SYSTEM FOR MONITORING AND CONTROLLING AN ELECTRONIC CIGARETTE DEVICE AND METHOD THEREOF

(71) Applicant: Lingxiao Li, Walnut, CA (US)

(72) Inventor: Lingxiao Li, Walnut, CA (US)

(21) Appl. No.: 17/114,442

(22) Filed: Dec. 7, 2020

Related U.S. Application Data
(60) Provisional application No. 62/946,873, filed on Dec. 11, 2019.

(51) Int. Cl. A24F 40/65; H04W 4/80; A24F 40/53

(52) U.S. Cl. CPC A24F 40/65; A24F 40/53; H04W 4/80

(57) ABSTRACT

In one aspect, a method for monitoring and controlling an electronic cigarette device may include steps of bluetooth pairing the electronic cigarette device and the electronic device; transferring data of the electronic cigarette device to the electronic device; analyzing the data from the electronic cigarette device in the electronic device; transferring signals including the analyzed data back to the electronic cigarette device; and adjusting the data in the electronic cigarette device according the analyzed data to personalize the electronic cigarette device.

### FIELD OF THE INVENTION

The present application generally relates to systems for monitoring and controlling an electronic cigarette device, and more particularly, to a system for monitoring and controlling an electronic cigarette device and method thereof.

### BACKGROUND OF THE INVENTION

Subject to the size of an electronic cigarette device, it is hard for all the developers to put dozens of chips inside to give it more advanced functions, such as usage data collection and calculation, fully customized heating curve, or even parental lock. Actually, these functions are very attractive to both customers and developers.

Therefore, there is a need for a system to provide monitor and control function for electronic cigarette devices.

### SUMMARY OF THE INVENTION

The present application discloses a system to provide monitor function and control function for the electronic cigarette device.

The system for monitoring and controlling an electronic cigarette device comprises a chip set and an electronic device. The chip set is installed in the electronic cigarette device and comprising a bluetooth chip. The electronic device is connected to the bluetooth chip for receiving data of the electronic cigarette device and sending signals to the electronic cigarette device.

In various exemplary embodiments, wherein the electronic device comprises a mobile application showing options for receiving the data and sending the signals.

In various exemplary embodiments, wherein the electronic cigarette device is a heat not burn electronic cigarette device.

In various exemplary embodiments, wherein the data comprises temperature record and time record.

In various exemplary embodiments, wherein the chip set further comprises a stroboscopic open/close circuit.

In various exemplary embodiments, wherein the electronic device is a tablet or a mobile phone.

In various exemplary embodiments, wherein the signals comprise temperature control signals.

In various exemplary embodiments, wherein the signals comprise turn on/off signals.

In various exemplary embodiments, wherein the chip set further comprises a memory.

A method for using the aforementioned system for monitoring and controlling the electronic cigarette device is also disclosed. The method comprises bluetooth pairing the electronic cigarette device and the electronic device; transferring the data of the electronic cigarette device to the electronic device; and transferring the signals to the electronic cigarette device.

In various exemplary embodiments, wherein after bluetooth pairing the electronic cigarette device and the electronic device, the method further comprises opening a mobile application showing options for receiving the data and sending the signals.

In various exemplary embodiments, wherein after transferring the data of the electronic cigarette device to the electronic device, the method further comprises calculating the data of the electronic cigarette device by the electronic device; and showing the analyzed data via a mobile application on the electronic device.

In various exemplary embodiments, wherein after transferring the data of the electronic cigarette device to the electronic device, the method further comprises saving the data in the memory; and sending the data to cloud.

Based on the above, the present application allows users to monitor and control the electronic cigarette device via the electronic device. Specifically, instead of calculating and saving all the data by the electronic cigarette device itself, the data can be sent to the synced electronic device for calculation. Since modern electronic device such as mobile phones or tablets are powerful enough to do all the advanced calculation, the problem of installing dozens of chips inside the electronic cigarette device can be solved.

In addition, the memory provides the function of saving the data, allowing the users to share the data by internet. The mobile application also allows the users to see analyzed data and select different options for controlling the electronic devices. The only thing the electronic cigarette device needs to work is to receive orders from the electronic device.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 illustrates a view of a system for monitoring and controlling an electronic cigarette device.

FIG. 2 illustrates a flow chart of a method for using the system for monitoring and controlling the electronic cigarette device.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

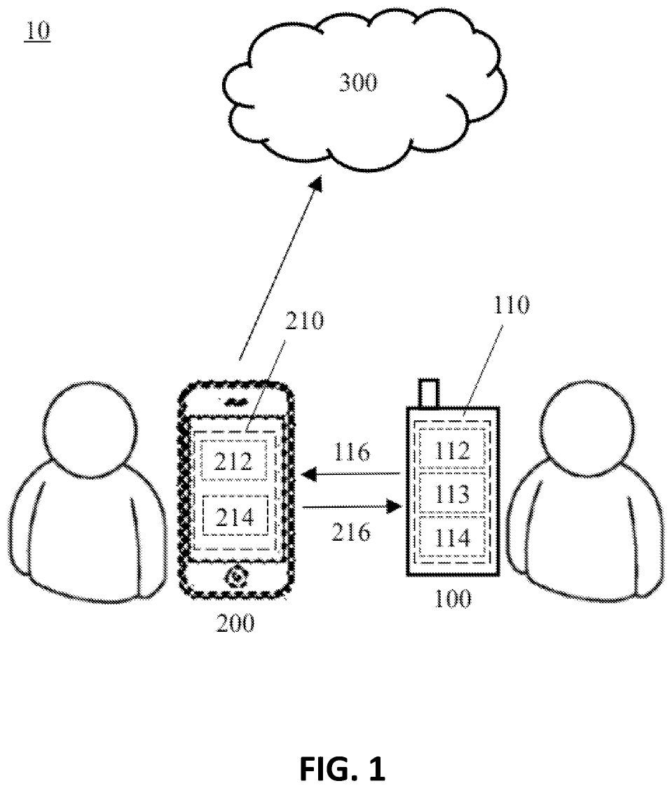

FIG. 1 illustrates a view of a system 10 for monitoring and controlling an electronic cigarette device 100.

Referring to FIG. 1, the system 10 may include the electronic cigarette device 100 and an electronic device 200. The electronic cigarette device 100 may include a chip set 110 installed therein. In one embodiment, the electronic cigarette device 100 in the present application is a heat not burn electronic cigarette device. However, the present application is not limited thereto. In a further embodiment, the chip set 110 may include a bluetooth chip 112, a stroboscopic open/close circuit 113 and a memory 114.

Still referring to FIG. 1, the electronic device 200 in the present application can be a tablet or a mobile phone, but not limited in the type of the electronic device 200 as long as the electronic device 200 can be bluetooth paired with the electronic cigarette device 100. The electronic device 200 is configured to show options for receiving data and sending signals. More specifically, a mobile application 210 is installed in the electronic device 200 for monitoring and controlling the electronic cigarette device 100. The mobile application 210 comprises a “receiving data” option 212 for receiving data 116 from the electronic cigarette device 100; and a “send signals back” option 214 for sending the signals 216 including analyzed data back to the electronic cigarette device. In summary, a feedback control system is formed to enhance the performance of the electronic cigarette device 100 through the electronic device 200. More specifically, when receiving the signals including the analyzed data from the electronic device 200, the data in the electronic cigarette device 100 can be adjusted accordingly so the electronic cigarette device 100 can be personalized according to the user preference.

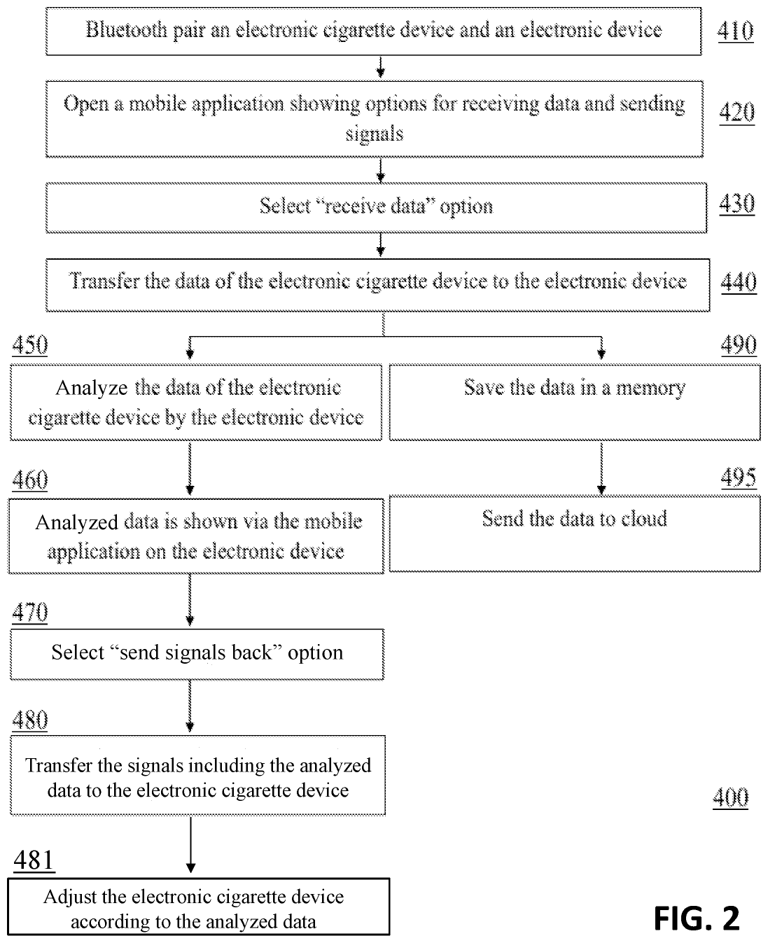

FIG. 2 illustrates a flow chart of a method 400 for monitoring and controlling the electronic cigarette device 100.

Referring to FIGS. 1-2, as shown in step 410, bluetooth pairing the electronic cigarette device 100 and the electronic device 200. As such, the electronic device 200 is connected to the bluetooth chip 112 for receiving the data 116 of the electronic cigarette device 100 and sending the signals 216 including the analyzed data back to the electronic cigarette device 100.

In detail, as shown in step 420, the user may open the mobile application 210 showing options 212/214 for receiving the data and sending the signals. Next, selecting the “receive data” option 212 as shown in step 430. In one embodiment, the data 116 may include at least temperature record and time record.

After that, the data 116 of the electronic cigarette device 100 is transferred to the electronic device 200. As shown in step 450, the electronic device 200 then analyzes the data 116 of the electronic cigarette device 200, and the analyzed data will be shown via the mobile application 210 on the electronic device as shown in step 460. Next, the user can select “send signals back” option 214 to send the signals including the analyzed data back to the electronic cigarette device 100 as shown in step 470. The analyzed data 216 in the present application comprise at least temperature control signals and turn on/off signals.

Last, as shown in step 480, the signals 216 including the analyzed data will be sent to the electronic cigarette device 100 to proceed the desired instruction. More specifically, the electronic cigarette device 100 can be adjusted according to the analyzed data as shown in step 481 to personalize the electronic cigarette device preferred by the user.

Also, as shown in step 490, the data 116 transferred from the electronic cigarette device 100 can be saved in the memory 114. As such, the data 116 can be saved and sent to a cloud 300 for saving or sharing as shown in step 495.

Based on the above, the present application allows users to monitor and control the electronic cigarette device via the electronic device. Specifically, instead of calculating and saving all the data by the electronic cigarette device itself, the data can be sent to the synced electronic device for calculation. Since modern electronic device such as mobile phones or tablets are powerful enough to do all the advanced calculation, the problem of installing dozens of chips inside the electronic cigarette device can be solved.

In addition, the memory provides the function of saving the data, allowing the users to share the data by internet. The mobile application also allows the users to see analyzed data and select different options for controlling the electronic devices. The only thing the electronic cigarette device needs to work is to receive orders from the electronic device and adjust accordingly.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A feedback control system for monitoring and controlling an electronic cigarette device, comprising:
a chip set installed in the electronic cigarette device and comprising a bluetooth chip; and
an electronic device connected to the bluetooth chip for receiving data of the electronic cigarette device, analyzing the data, and sending signals including the analyzed data back to the electronic cigarette device to adjust the data of the electronic cigarette device and further personalize the electronic cigarette device.

2. The feedback control system for monitoring and controlling an electronic cigarette device of claim 1, wherein the electronic device comprises a mobile application showing options for receiving the data and sending the signals.

3. The feedback control system for monitoring and controlling an electronic cigarette device of claim 1, wherein the electronic cigarette device is a heat not burn electronic cigarette device.

4. The feedback control system for monitoring and controlling an electronic cigarette device of claim 1, wherein the data comprises temperature record and time record.

5. The feedback control system for monitoring and controlling an electronic cigarette device of claim 1, wherein the chip set further comprises a stroboscopic open/close circuit.

6. The feedback control system for monitoring and controlling an electronic cigarette device of claim 1, wherein the electronic device is a tablet or a mobile phone.

7. The feedback control system for monitoring and controlling an electronic cigarette device of claim 1, wherein the signals comprise temperature control signals.

8. The feedback control system for monitoring and controlling an electronic cigarette device of claim 1, wherein the signals comprise turn on/off signals.

9. The feedback control system for monitoring and controlling an electronic cigarette device of claim 1, wherein the chip set further comprises a memory.

10. A method for monitoring and controlling an electronic cigarette device comprising steps of:
bluetooth pairing the electronic cigarette device and the electronic device;
transferring data of the electronic cigarette device to the electronic device;
analyzing the data from the electronic cigarette device in the electronic device;
transferring signals including the analyzed data back to the electronic cigarette device; and
adjusting the data in the electronic cigarette device according the analyzed data to personalize the electronic cigarette device.

11. The method for monitoring and controlling an electronic cigarette device of claim 10, wherein after bluetooth pairing the electronic cigarette device and the electronic device, the method further comprises opening a mobile application showing options for receiving the data and sending the signals.

12. The method for monitoring and controlling an electronic cigarette device of claim 10, further comprising a step of showing the analyzed data via a mobile application on the electronic device after the step of analyzing the data from the electronic cigarette device in the electronic device.

13. The method for monitoring and controlling an electronic cigarette device of claim 10, further comprising a step of saving the data in a memory after transferring the data of the electronic cigarette device to the electronic device.

14. The method for monitoring and controlling an electronic cigarette device of claim 10, further comprising a step of sending the data to cloud after saving the data in the memory.
